(19) United States
(12) Patent Application Publication
(10) Pub. No.: US 2017/0371341 A1
(43) Pub. Date: Dec. 28, 2017

(54) METHOD AND APPARATUS FOR CONTROLLING A ROBOTIC CLEANING DEVICE FOR INTENSIVE CLEANING

(71) Applicant: NEATO ROBOTICS, INC., Newark, CA (US)

(72) Inventors: Henry Arthur LEINHOS, Stanford, CA (US); Chang Young KIM, Newark, CA (US); Sarath Kumar SUVARNA, Fremont, CA (US); Steven Mathew ALEXANDER, Fremont, CA (US); Michael R. PERKINS, Los Gatos, CA (US)

(73) Assignee: NEATO ROBOTICS, INC., Newark, CA (US)

(21) Appl. No.: 14/674,858

(22) Filed: Mar. 31, 2015

(51) Int. Cl. G05D 1/02; A47L 11/40

(52) U.S. Cl. CPC G05D 1/0219; A47L 11/4011

(57) ABSTRACT

A robotic cleaning device and method of control thereof. The device and method enable multiple cleaning passes within an environment efficiently, cleaning the entire environment more than once, or cleaning the entire environment and then focusing on one or more particularly dirty areas to provide enhanced cleaning by making one or more passes over a dirty area in a dominant and a non-dominant direction. The robotic cleaning device may identify such areas in the course of its cleaning, or it may record such areas previously as being historically dirty and requiring additional attention. The device may vacuum; it may shampoo; it may polish; or it may perform other cleaning operations. Where the device is battery-powered, the device may check its state of charge before performing the enhanced cleaning, and may repeat the enhanced cleaning if the battery or batteries have sufficient charge.

### BACKGROUND

Aspects of the present invention relate to robotic cleaning devices, and more particularly to robotic cleaning devices which, either autonomously or through manual instruction, traverse one or more selected areas of an environment to provide enhanced cleaning in those areas.

There are robotic cleaning devices which traverse environments, without regard to the shape of the environment, or to the presence of obstacles in the environment. These devices may make multiple passes through portions of a given environment, not so much by design as by virtue of the devices' running through the environment until their portable power runs out, or until some predetermined period of time elapses. Such devices do not focus on particular portions of the environment that may need more cleaning than do other portions. Such devices also may make multiple passes, unintentionally, on portions of the environment which do not need additional cleaning.

There also are robotic cleaning devices which map the environments the devices traverse, and then traverse the environments systematically. Such devices may make only one pass through the environment, without regard to whether there are portions of that environment that may need more cleaning than do other portions. These devices may be more energy efficient than the devices which simply run until their portable power runs out, but the resulting cleaning could stand improvement.

In neither of the cases just mentioned, is there any special attention paid to particularly dirty areas. Consequently, the inventors have identified a need to provide a robotic cleaning device which pays special attention to such areas.

### BRIEF DESCRIPTION OF THE DRAWINGS

FIG. 1 depicts a mode of movement of a robotic cleaning device traversing an environment.

FIG. 2 depicts another mode of movement of a robotic cleaning device traversing an environment.

FIG. 3 depicts an exemplary environment (a room), with obstacles.

FIG. 4 depicts the environment of FIG. 3 with the mode of traversal of FIG. 1.

FIG. 5 depicts the environment of FIG. 3 with the mode of traversal of FIG. 2.

FIG. 6 depicts an overlay of the traversal modes of FIGS. 4 and 5.

FIG. 7 depicts an overlay of the traversal modes of FIGS. 4 and 5, as applied to one area of the environment of FIG. 3.

FIG. 8 depicts the overlay of FIG. 6, but with a connection between each traversal mode.

FIG. 9 is a flow chart for an aspect of operation of the robotic cleaning device according to an embodiment.

FIG. 10 is a flow chart for an aspect of operation of the robotic cleaning device according to an embodiment.

FIG. 11 is a flow chart for an aspect of operation of the robotic cleaning device according to an embodiment.

FIG. 12 is a flow chart for an aspect of operation of the robotic cleaning device according to an embodiment.

FIG. 13 is a flow chart for an aspect of operation of the robotic cleaning device according to an embodiment.

FIG. 14 is a high level diagram of the robotic cleaning device and associated apparatus.

### DETAILED DESCRIPTION

The following description relates to a robotic cleaning device which can make multiple cleaning passes within an environment efficiently, cleaning the entire environment more than once, or cleaning the entire environment and then focusing on one or more particularly dirty areas to provide enhanced cleaning. The robotic cleaning device may identify such areas in the course of its cleaning, or it may record such areas previously as being historically dirty and requiring additional attention. Other ways of identifying dirty areas will be known to ordinarily skilled artisans.

In one aspect, the robotic cleaning device will clean an environment, such as a room, by making as few turns as possible while traversing the environment. Cleaning in this manner is known as cleaning in the dominant direction. Making fewer turns can lower the time required to make a pass through the entire environment. With battery-operated devices, saving time can mean conserving battery power.

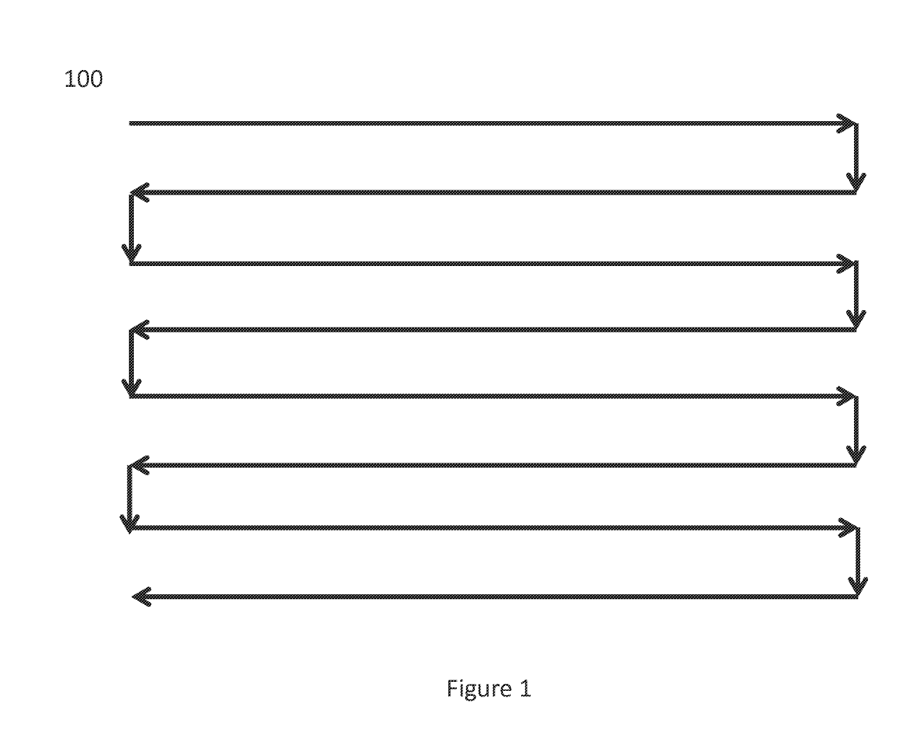

FIG. 1 depicts a traversal of the robotic cleaning device in an environment or area, such as a room. Rooms can have various shapes. For ease of discussion, and merely by way of example, the environment is rectangular. In such an environment, causing the robotic cleaning device to travel along the longer dimension of the room would require fewer turns to make a pass through the entire environment. Consequently, the traversal 100 in FIG. 1 is a traversal in the dominant direction.

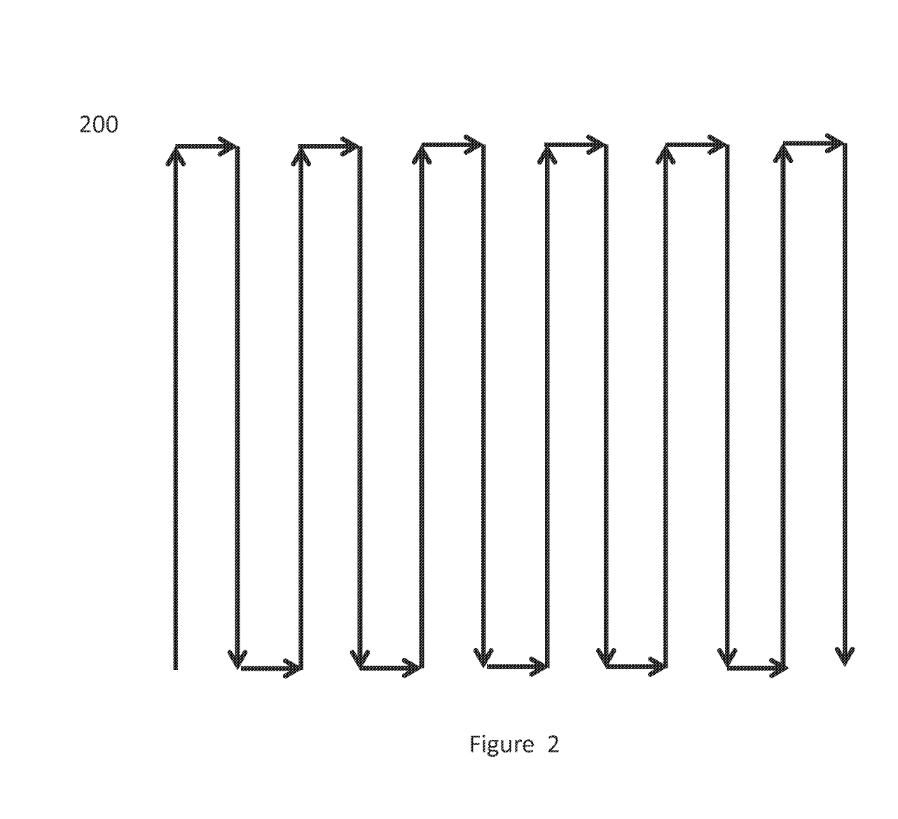

FIG. 2 also depicts a traversal of the robotic cleaning device in a rectangularly-shaped environment. In FIG. 2, the robotic cleaning device travels along the shorter dimension of the room, thus requiring more turns in order to make a pass through the entire environment. Consequently, the traversal 200 in FIG. 2 is a traversal in the non-dominant direction, which here is perpendicular to the dominant direction.

As can be appreciated, where the environment to be cleaned is carpeted, traversal of the robotic cleaning device in the dominant direction can mean cleaning with the pile of the carpet. Traversal of the robotic cleaning device in the non-dominant direction can meaning cleaning transverse to the carpet pile. Each mode of traversal can be effective with respect to dirt removal in a way that the other mode of traversal would not be.

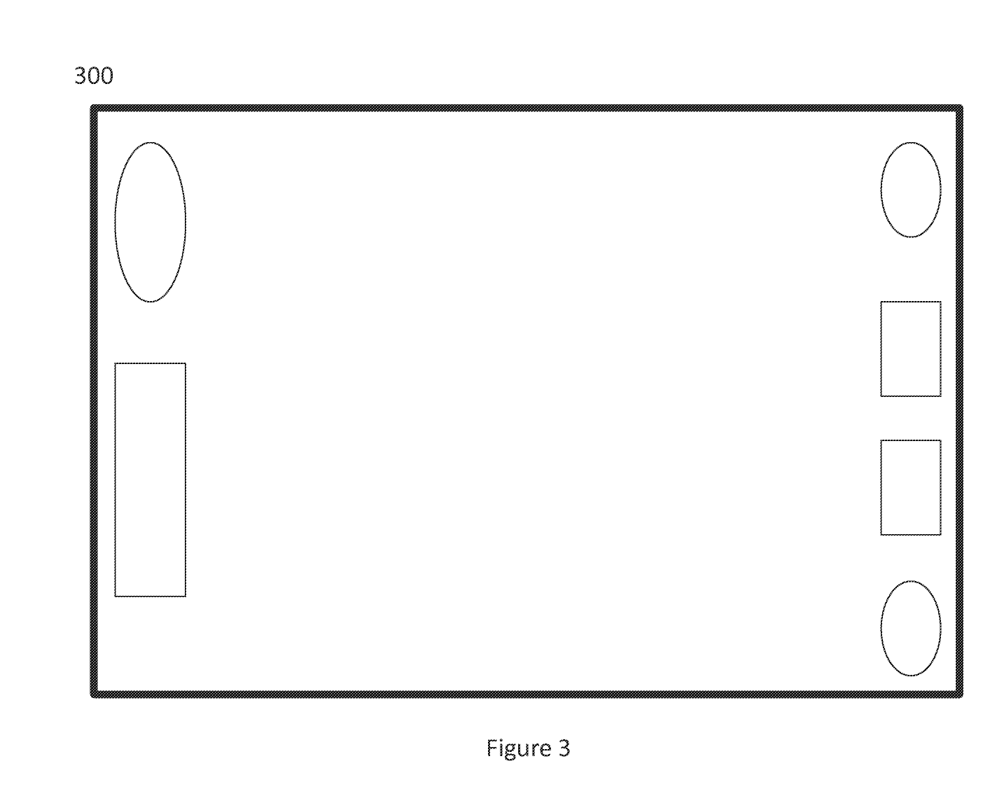

FIG. 3 depicts an environment, or room 300 in which the robotic cleaning device may operate. Various obstacles are positioned in the room. When cleaning, the robotic cleaning device avoids these obstacles in any of several ways known to ordinarily skilled artisans. In one aspect, before traversing the room, the robotic cleaning device may scan the room and make a map of the area to be cleaned, noting the obstacles in the room. Consulting the map while traversing the room may enable the robotic cleaning device to avoid the obstacles.

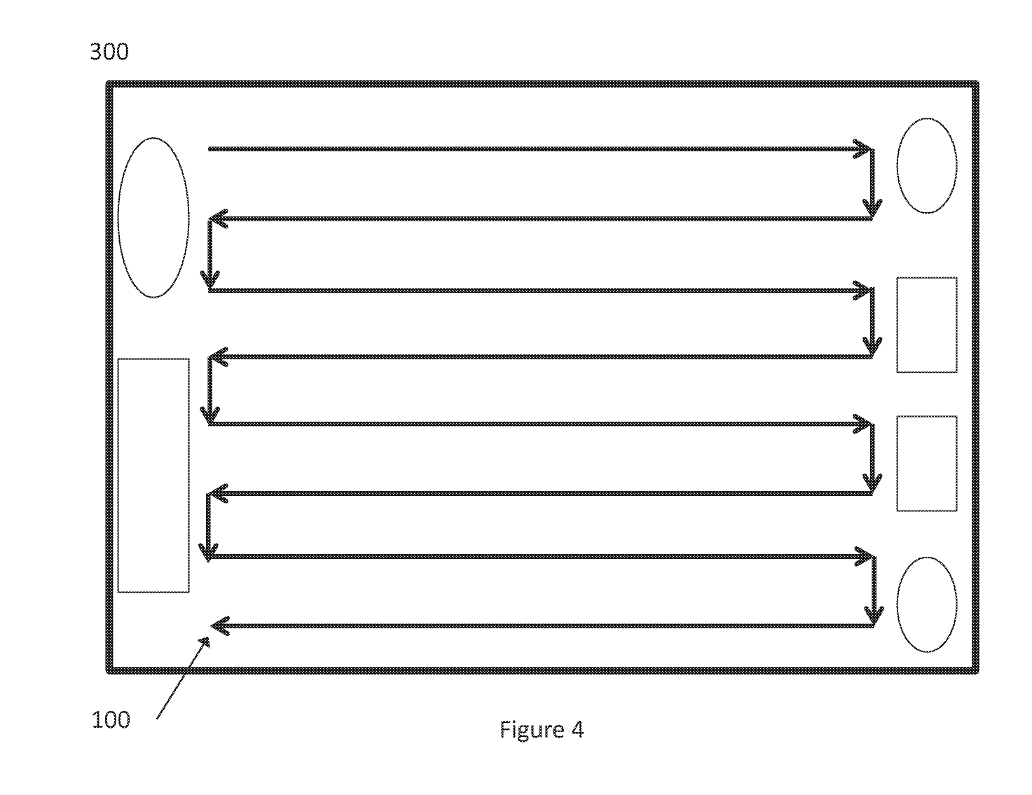

FIG. 4 shows the traversal path 100 within the room 300. In one mode of operation, the robotic cleaning device may pass along the boundary of the room 300, cleaning along the walls of the room, before initiating its dominant direction traversal.

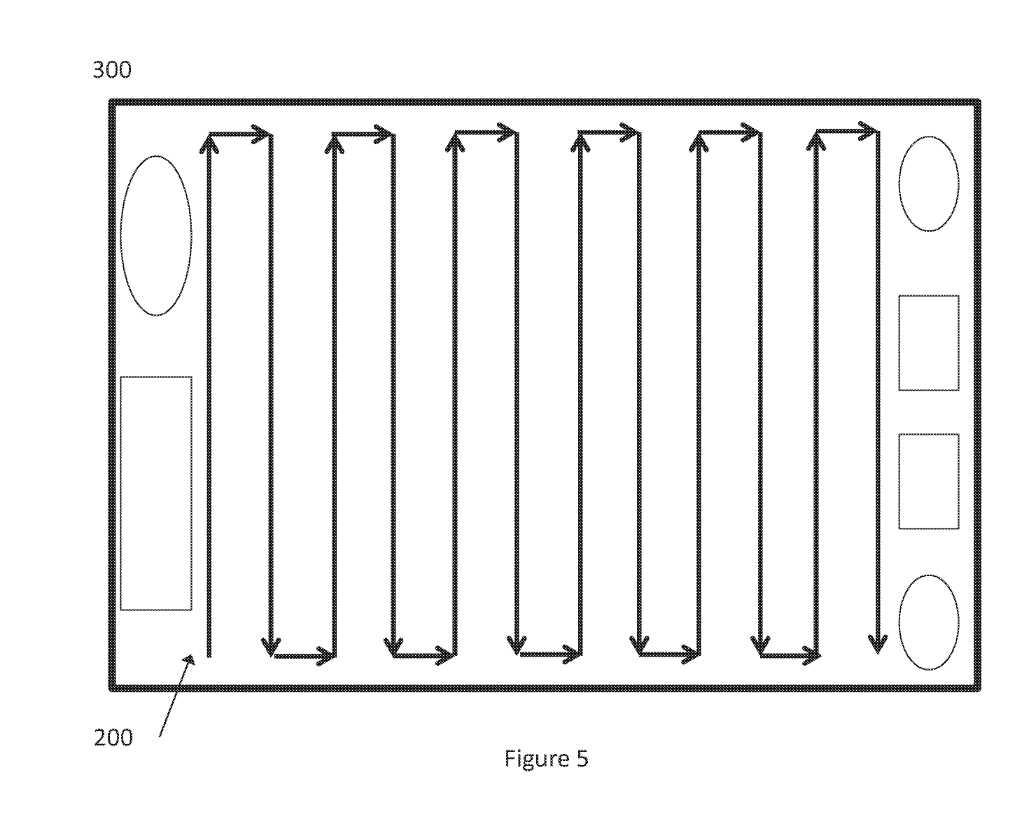

FIG. 5 shows the traversal path 200 within the room 300. In one mode of operation, the robotic cleaning device may pass along the boundary of the room 300, cleaning along the walls of the room, before initiating its non-dominant direction traversal.

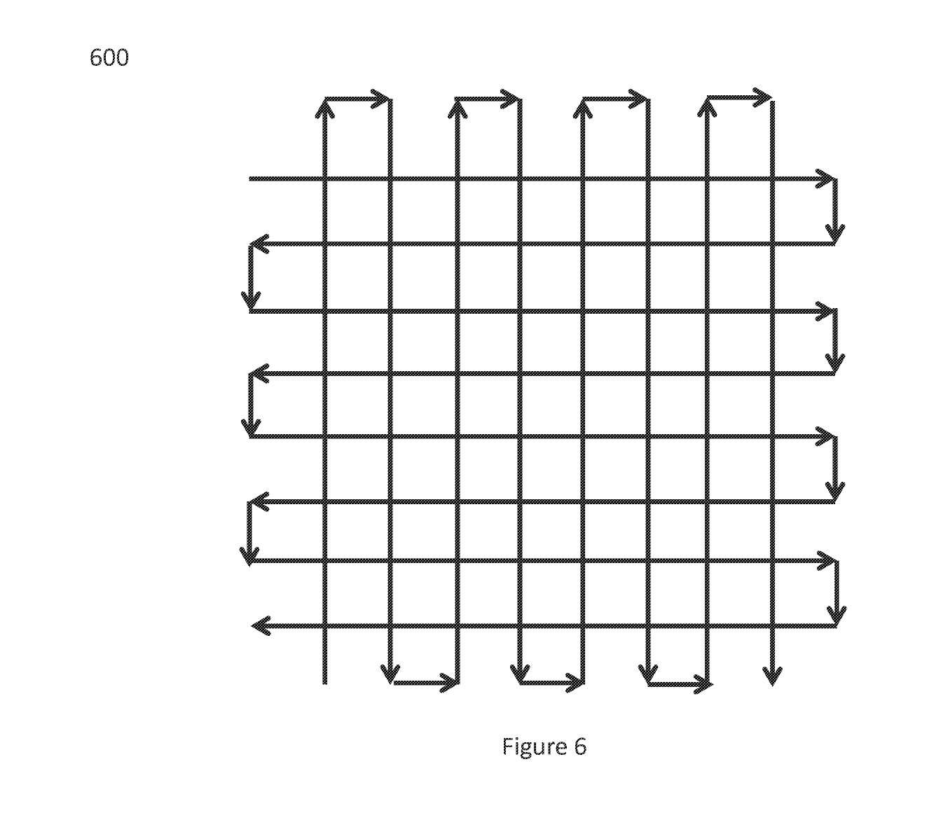

FIG. 6 shows traversal paths 100 and 200 superimposed on each other as a pattern 600. In one aspect of operation, the robotic cleaning device may traverse the room at least twice, first in the dominant direction, and then in the non-dominant direction.

In one aspect, in the course of cleaning, the robotic cleaning device may detect that a particular area of the room 300 has a lot of dirt. Various ways of accomplishing such detection are well known to ordinarily skilled artisans. For example, the robotic cleaning device may have a dirt sensor which detects the presence of dirt or other debris in the robotic cleaning device's path. The device may record locations of particularly dirty areas in its map, and may come back to those particular dirty areas for one or more further passes. In one aspect, those passes may be in the dominant direction, the non-dominant direction, or both.

In one aspect, the robotic cleaning device may record known high-traffic or dirty areas in its map. The device may use such recorded information to go directly to a known dirty area and perform multiple passes at the beginning of the device's cleaning routine, or as the device's cleaning routine per se, without cleaning remaining areas of the environment.

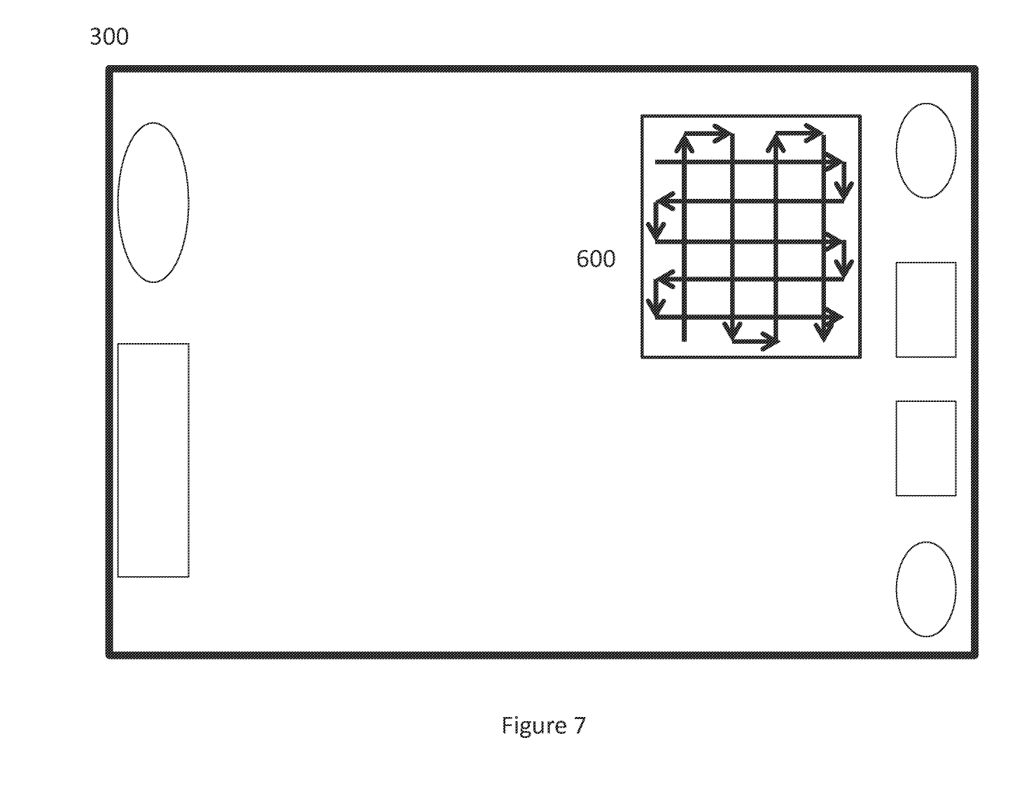

FIG. 7 depicts the FIG. 6 pattern 600 within an environment 300. In one aspect, the robotic cleaning device may clean the environment 300, for example, in the dominant direction, and then move to an area within the environment 300 for more intensive cleaning. In one aspect, that more intensive cleaning may involve making a pass in the area in the dominant direction, and then a second pass in the area in the non-dominant direction.

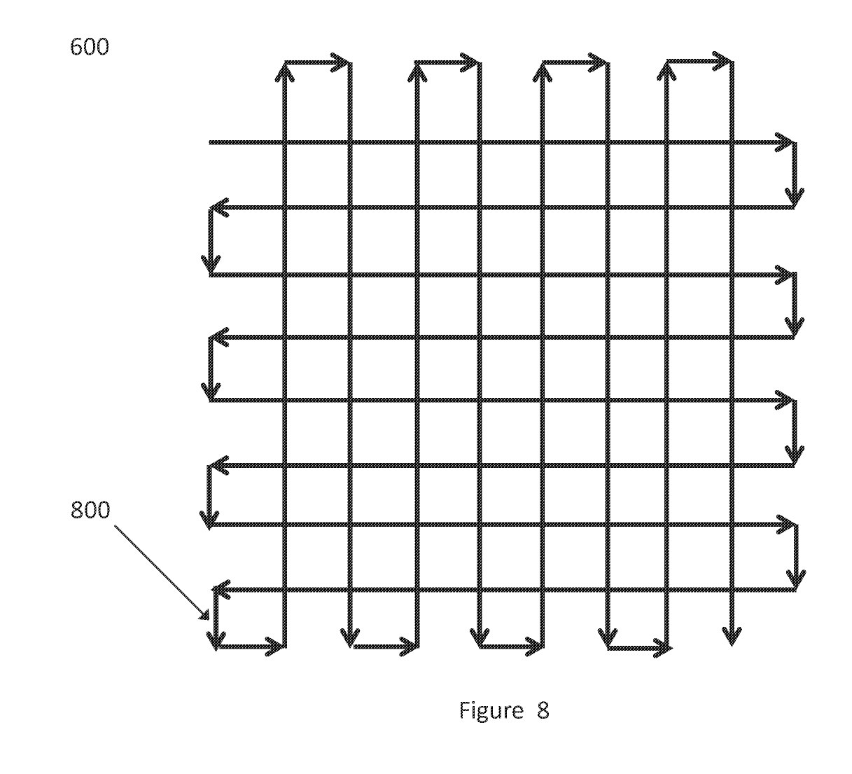

FIG. 8 shows pattern 600 with a connecting path 800 between the dominant and non-dominant directions. In FIG. 8, the connection path is configured so that the robotic cleaning device traverses the area in the non-dominant direction, and then in the dominant direction. This traversal order illustrates that it does not matter whether the robotic cleaning device begins its traversal in the dominant direction, or in the non-dominant direction.

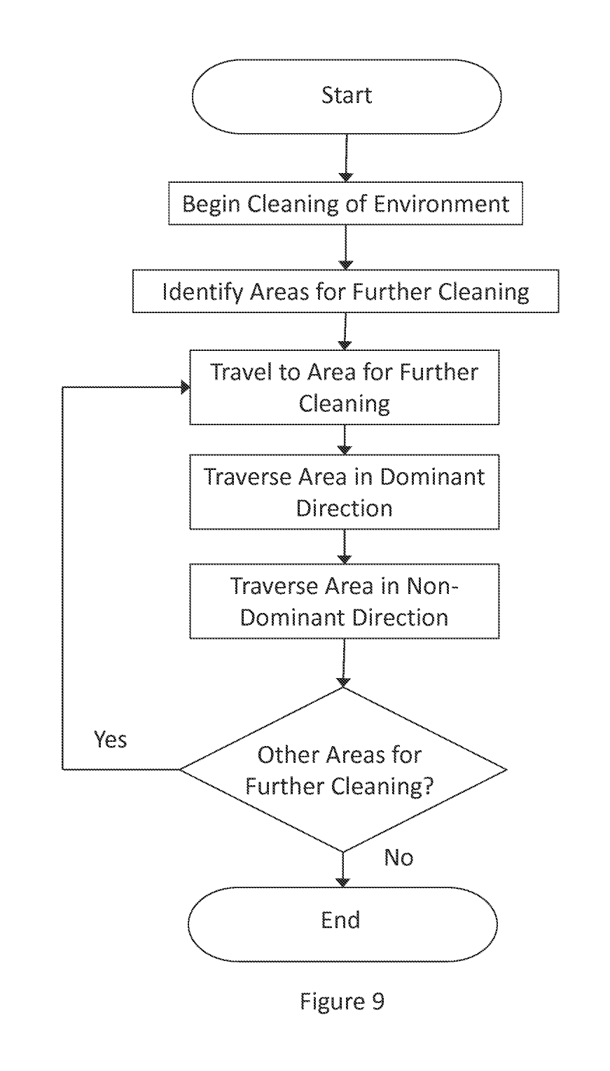

FIGS. 9-13 are flow charts depicting various modes of operation of the robotic cleaning device in providing more intensive cleaning in an environment, or in an area within the environment. In these flow charts, depiction of a particular sequence of actions does not imply a requirement that the depicted sequence is the only acceptable sequence. Various actions within a particular flow chart may be performed in different orders, or may be repeated more times than expressly shown in the flow chart.

Looking now at FIG. 9, in one aspect a robotic cleaning device may begin cleaning of an environment. That beginning may involve traversing the periphery or boundaries of the environment. Alternatively, that traversal may occur later in the device's operating cycle, or at the end of the cycle. In any event, this cleaning will involve traversal of the environment in either a dominant or non-dominant direction, as depicted in FIGS. 1 and 2.

In the described aspect, after beginning to clean the environment, the robotic cleaning device may identify areas for further cleaning. Various ways of identifying these areas will be known to ordinarily skilled artisans. By way of non-limiting example, the device may identify particular areas in the course of making a pass through the environment as depicted in either FIG. 1 or FIG. 2. The device may record the location(s) of these area(s) to facilitate moving to these areas for further cleaning. After making a pass through the environment, the device may travel to one or more of these areas. As another non-limiting example, the device may have particular areas stored previously in a map. Again, after making a pass through the environment, the device may travel to one or more of these areas.

After traveling to an area requiring further cleaning, the robotic cleaning device may traverse the area in the dominant direction, followed by traversal in the non-dominant direction. This traversal sequence is not critical, and may be reversed.

After performing two passes through the identified area, the robotic cleaning device may check whether there are other areas requiring further cleaning. If there are, the device may travel to a second area and perform the further cleaning as described previously. If there are no more areas to be cleaned, the robotic cleaning device may complete its cleaning cycle, for example, by returning to a charging base to have its battery or batteries recharged.

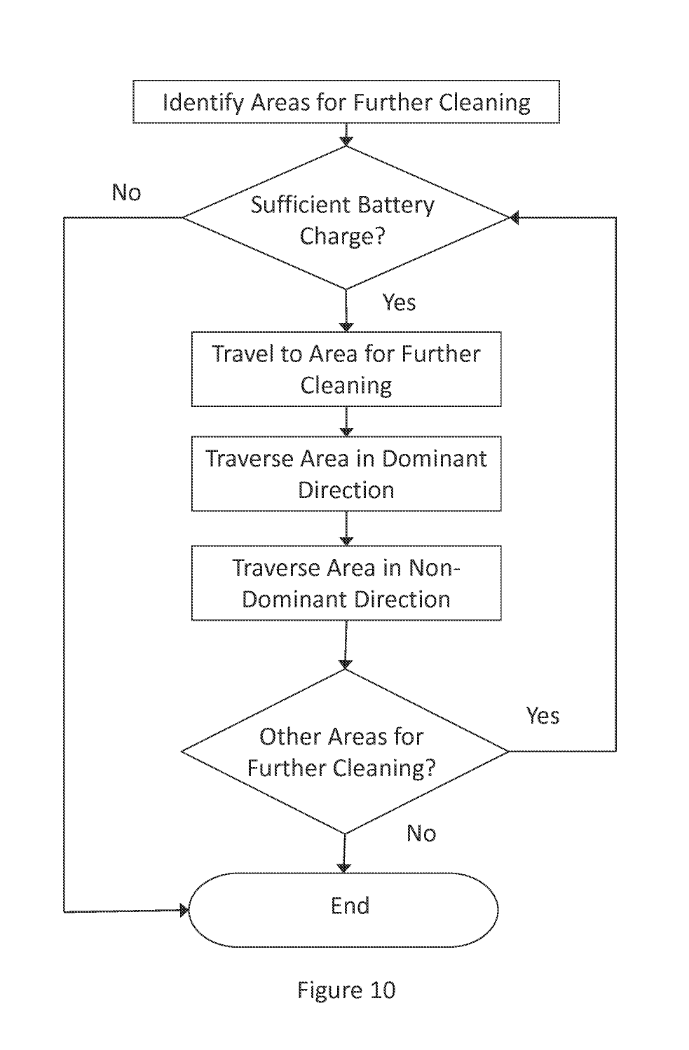

The flow chart in FIG. 10 focuses on the further cleaning steps in FIG. 9. In FIG. 10, after identifying one or more areas for further cleaning, the robotic cleaning device checks whether it has sufficient charge in its battery or batteries to enable completing a pass through the first identified area. If there is sufficient charge, the device proceeds to perform the further cleaning in that area, as described above with respect to FIG. 9. If there is not sufficient charge, the device ends its cleaning cycle, for example, by returning to the charging base. In one aspect, the device may be required to have at least 50 percent of its charge remaining before initiating a pass through the identified area.

After completing further cleaning of an identified area, the robotic cleaning device may check whether there are other areas requiring further cleaning. Actions taken after this check are as discussed above with respect to FIG. 9. Here again, in one aspect, the device may be required to have at least 50 percent of its battery charge remaining before initiating any passes through additional identified areas.

In FIG. 10, the robotic cleaning device need not check its battery charge only after identifying areas for further cleaning. Rather, the device could monitor its battery charge more frequently, and may break off a particular pass in a particular area in the middle of cleaning before the charge gets too low to enable the device to return to its home base for recharging. In one aspect, the device may return to base when it has 15 percent or less of a full battery charge.

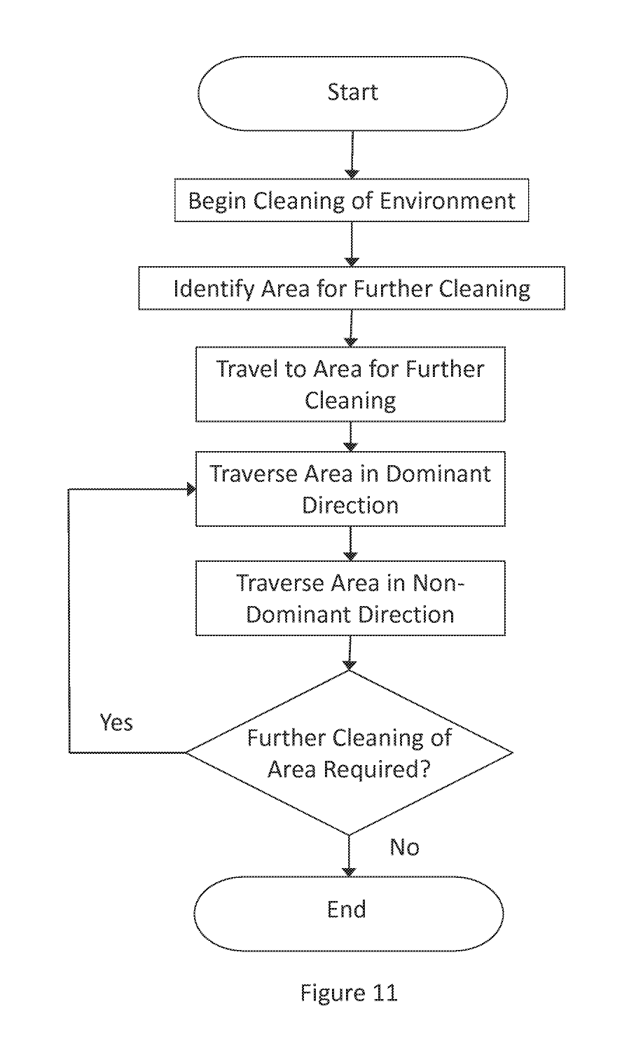

FIG. 11 depicts a variant in which the robotic cleaning device focuses more intensely on a particular area requiring further cleaning. After performing further cleaning on the area as discussed with respect to FIG. 9, the device may check whether still further cleaning in that area is required. Determination of a requirement for further cleaning may take various forms, as will be known to ordinarily skilled artisans. As one non-limiting example, the device may determine, in real time, that it has picked up sufficient dirt in its first pass through the identified area that a further pass is warranted. As another non-limiting example, a memory in the robotic cleaning device may record information indicating that one or more affected areas require multiple passes for further cleaning, if possible. As a yet further non-limiting example, a user may instruct the robotic cleaning device to travel directly to an area to provide intensive cleaning. The user's instruction may include a preprogrammed or otherwise predetermined number of passes through that area. Alternatively, the user may instruct the device to perform a particular number of passes through that area. In accordance with this last example, the device may begin its cleaning of the environment by traveling directly to the area in question.

In the sequence that FIG. 11 depicts, after a first pass through the area, if the device determines that further cleaning of the area is required, or if the device has not yet completed the instructed number of passes through the area, the robotic cleaning device performs that further cleaning. If further cleaning is not required, or the device has completed its instructed number of passes, the robotic cleaning ends its cleaning cycle, for example, by returning to a charging base to have its battery or batteries recharged.

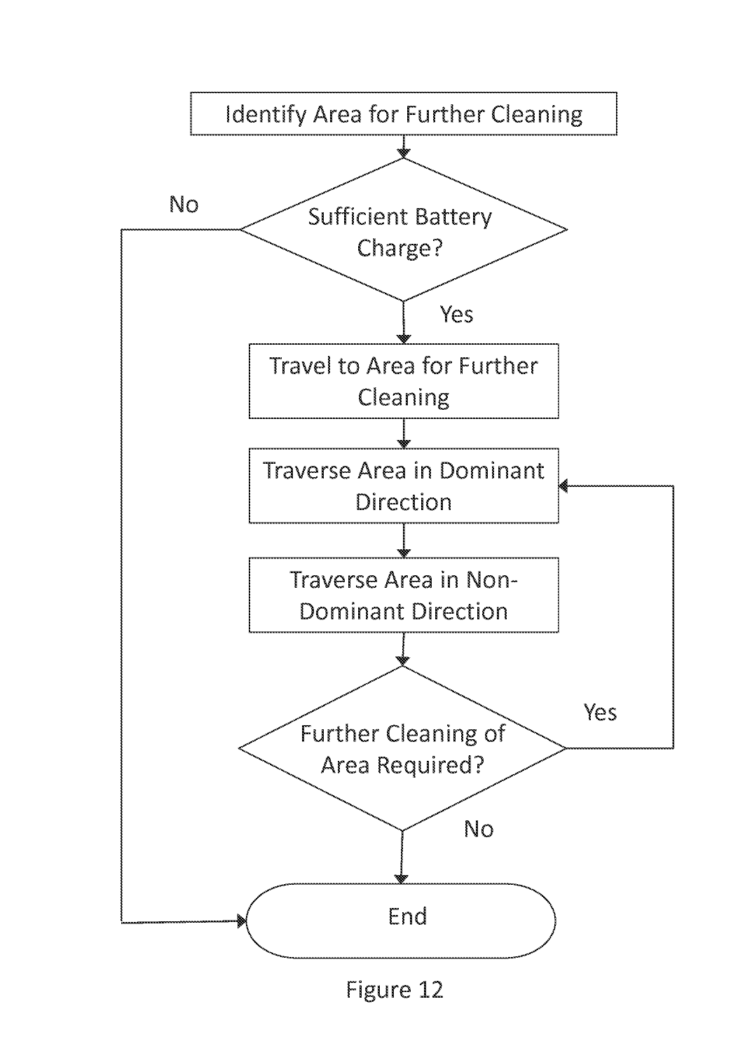

The flow chart in FIG. 12 focuses on the further cleaning steps in FIG. 11. In FIG. 12, after identifying an area for further cleaning, the robotic cleaning device checks whether it has sufficient charge in its battery or batteries to enable completing a pass through the area. If there is sufficient charge, the device proceeds to perform the further cleaning in that area, as described above with respect to FIG. 11. If there is not sufficient charge, the device ends its cleaning cycle, for example, by returning to the charging base.

After completing further cleaning of the area, the robotic cleaning device may check whether the area requires further cleaning. Actions taken after this check are as discussed above with respect to FIG. 11.

In FIG. 12, the robotic cleaning device need not check its battery charge only after identifying areas for further cleaning. Rather, the device could monitor its battery charge more frequently, and may break off a particular pass in a particular area in the middle of cleaning before the charge gets too low to enable the device to return to its home base for recharging.

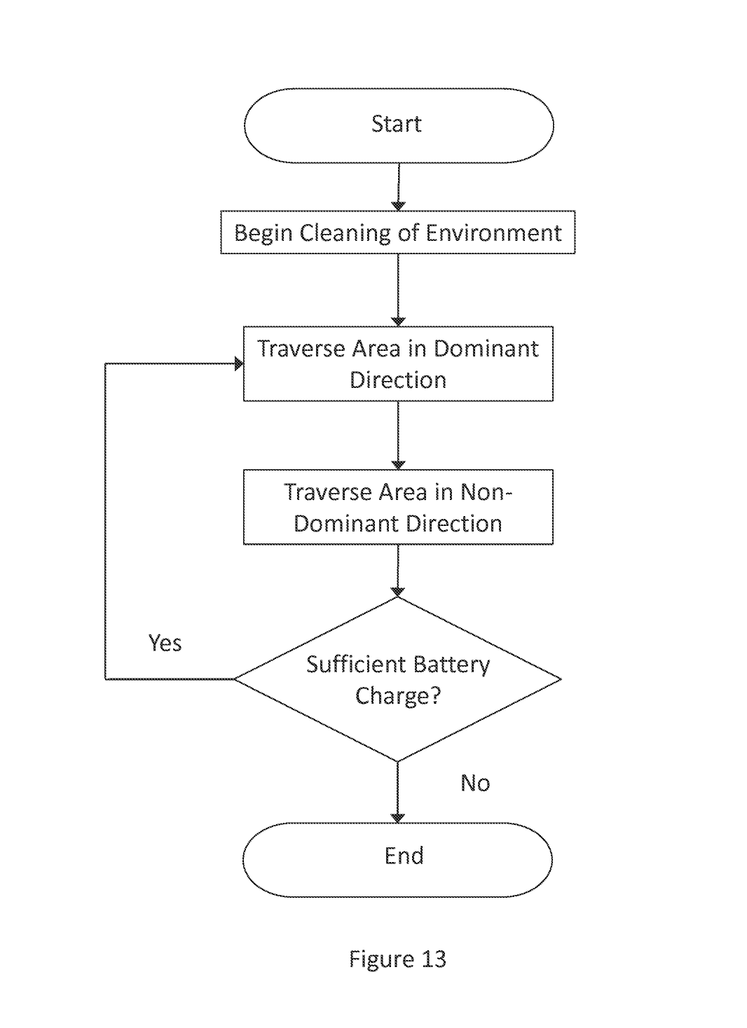

The flow chart in FIG. 13 focuses on a variant of the further cleaning steps in FIG. 12. In FIG. 13, after traveling to an identified area for further cleaning and completing a first pass through that area, the robotic cleaning device checks whether it has sufficient charge in its battery or batteries to enable completing another pass through the area. If there is sufficient charge, the device proceeds to make another pass, as described above with respect to FIG. 12. If there is not sufficient charge, the device ends its cleaning cycle, for example, by returning to the charging base.

In FIG. 13, the number of passes through an area to provide further cleaning is limited by remaining battery charge.

While not specifically shown in FIGS. 9-13, as previously discussed, the robotic cleaning device could perform intensive cleaning on an entire environment, rather than focusing on a particular area within that environment. Battery charge limitations in the device may limit the size of the environment in which the device could perform the intensive cleaning, but in any event it is within the contemplation of the invention to enable the device to travel in one or more iterations of the traversal pattern shown in FIG. 6 within the overall environment.

In focusing on an entire environment rather than on a particular area within that environment, before beginning its cleaning, the robotic cleaning device may determine that the environment to be cleaned is sufficiently small that it is possible to perform multiple passes through the area. The device may make this determination by consulting a previous map of the environment and noting the size, or the device may scan the environment prior to beginning cleaning, and may determine the size of the environment as a result of that scanning. In one aspect, an environment size of 4m×4 m or smaller may qualify as being sufficiently small for the device to engage in this mode of operation. In one aspect, the determination of environmental size may be based on the expected amount of battery charge needed to make a pass through the environment in the dominant and non-dominant directions.

As noted previously, particular action sequences that FIGS. 9-13 depict are not required. Battery charge monitoring can occur at a different time or times. Area or environment traversal can begin with the non-dominant direction rather than with the dominant direction. Other variants will be apparent to ordinarily skilled artisans.

Also, as an alternative to monitoring of battery charge, the device could operate for a predetermined period of time, and may make as many passes through the area or the environment that that predetermined period of time will allow. As a further alternative, the device could monitor its state of battery charge while operating for the predetermined period of time, and break off cleaning if the device determines that its battery charge is getting too low to enable the device to return to its base. In one aspect, the time limit may be 15 minutes.

In one aspect, more intensive cleaning can require more battery power than does regular cleaning. As a result, as one of the conditions for being in a more intensive cleaning mode, the robotic cleaning device may be programmed, for example, to return to base and charge more frequently than would be the case if the device were in a regular cleaning mode.

In one aspect, the device may consult the same maps in the more intensive cleaning mode as in the regular cleaning mode. Alternatively, there may be special maps that the device may consult for the more intensive cleaning mode. For example, the maps identifying areas requiring that more intensive cleaning may be specific to the intensive cleaning mode.

The type of cleaning that the robotic cleaning device does is not critical to the invention. The device may vacuum; it may shampoo; it may polish; or it may perform other cleaning operations. Where dispensing of cleaning material is involved in cleaning, monitoring of remaining cleaning material levels would be one criterion for determining how many passes for further cleaning that the device can make, or in how many identified areas the device can perform further cleaning. As an alternative, cleaning material capacity of the device could be set based on maximum battery capacity or on the desired duration of a cleaning cycle.

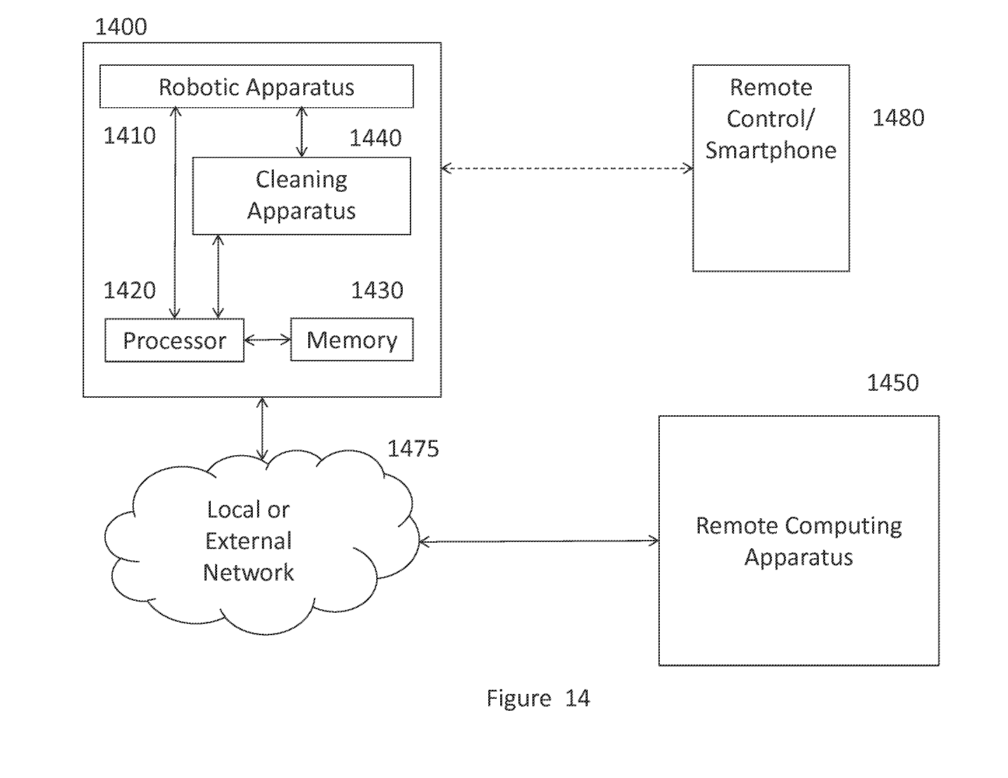

FIG. 14 shows a high level diagram of apparatus with which a robotic cleaning device in accordance with embodiments of the invention may interact. In FIG. 14, robotic cleaning device 1400 includes robotic apparatus 1410 which may operate autonomously, semiautonomously, or under control of another entity, as will be known to ordinarily skilled artisans. Processor 1420 executes instructions to control robotic apparatus 1410, as well as cleaning apparatus 1440, which may enable cleaning in any of the ways mentioned herein, in ways known to ordinarily skilled artisans. Device 1400 may receive instructions from a remote control 1480 which a user operates. The user instructions may include one or more of the operational modes described earlier with respect to FIG. 11, as well as other operational modes that are well known to ordinarily skilled artisans, including but not limited to operations described with reference to any of FIGS. 9-13. The remote control 1480 may be a discrete device, or may be implemented as an app on a smartphone, tablet, or similar device. Remote control also may be accomplished via more substantial apparatus, such as a notebook or desktop computer, or a server. Device 1400 may communicate with remote control 1480 via suitable wireless communication, including but not limited to infrared (IR), Bluetooth®, or WiFi®.

Processor 1420 facilitates the generation of a map of the robotic cleaning device's environment when the device initiates its cleaning procedure. Processor 1420 may include sufficient memory to store a map or maps of the environment(s) in which robotic cleaning device 1400 operates. Alternatively, processor 1420 may access additional memory 1430 which stores the map(s). Device 1400 also may communicate with computing apparatus 1450 which stores the map(s). Communication between robotic cleaning device 1400 and computing apparatus 1450 to access the map(s) may be via wireless communication on a local area network or external network 1475 such as the Internet (also referred to as the cloud).

Although the invention has been described in language specific to structural features and/or methodological steps, it is to be understood that the invention is not to be limited to the specific features or steps disclosed. Rather, the specific features and steps are disclosed as preferred forms of implementing the invention, which is to be defined by the claims.

1. A robotic cleaning device comprising:
a robotic apparatus including cleaning apparatus; and
a processor executing instructions that control movement of the robotic apparatus to clean at least a portion of an environment to be cleaned by causing the robotic apparatus to do the following:
access at least a partial map of the environment to be cleaned;
identify on the partial map a first normal cleaning portion and a second, intensive cleaning portion of the environment to be cleaned, the second, intensive cleaning portion being identified for cleaning more intensively than the first portion, and thereby create a map of intensive cleaning locations;
traverse the first portion of the environment with a single pass over at least part of the first portion; and
in response to a recorded intensive cleaning location indicated on the map of intensive cleaning portions, traverse the second, intensive cleaning portion of the environment with multiple passes over at least part of the second, intensive cleaning portion, wherein the multiple passes are in different directions.

2. A robotic cleaning device as claimed in claim 1, wherein the multiple passes are in dominant and non-dominant directions that are perpendicular to each other.

3. A robotic cleaning device as claimed in claim 1, wherein the processor executes further instructions that control movement of the robotic apparatus to clean the second, intensive cleaning portion of the environment by causing the robotic apparatus to do the following, prior to the traversing recited in claim 1:
access a map of the environment to be cleaned, the map indicating at least one second, intensive cleaning portion of the environment; and
traverse the environment to perform cleaning of the environment.

4. A robotic cleaning device as claimed in claim 3, wherein the robotic apparatus traverses the environment in the dominant direction for the single pass over at least part of the first portion.

5. A robotic cleaning device as claimed in claim 3, wherein the processor executes further instructions that control movement of the robotic apparatus to clean at least a portion of the second portion of the environment by causing the robotic apparatus to do the following after traversing the environment to perform cleaning of the first portion of the environment and prior to the traversing recited in claim 1:
identify the second portion of the environment that requires additional cleaning; and
travel to the second portion of the environment to begin the traversing recited in claim 1.

6. A robotic cleaning device as claimed in claim 1, further comprising:
a dirt sensor;
the processor being programed to execute further instructions to create the map of the environment to be cleaned, the map indicating at least one second, intensive cleaning portion of the environment, in response to signals from the dirt sensor.

7. A robotic cleaning device comprising:
a robotic apparatus including cleaning apparatus; and
a processor executing instructions that control movement of the robotic apparatus to clean at least a portion of an environment to be cleaned by causing the robotic apparatus to do the following:
execute instructions to identify an intensive cleaning portion of a map of the environment to be cleaned in response to instructions from a user;
access the map;
traverse a first portion of the environment without cleaning the first portion, to reach the intensive cleaning portion of the map; and
in response to the identified intensive cleaning portion of the map, traverse the second, intensive cleaning portion of the environment with multiple passes over at least part of the second, intensive cleaning portion, wherein the multiple passes are in different directions.

8. A robotic cleaning device as claimed in claim 7, further comprising a remote control configured to accept the instructions from a user identifying the second, intensive cleaning portion.

9. A robotic cleaning device as claimed in claim 1, further comprising a memory that stores at least the partial map of an environment to be cleaned, wherein the processor accesses the at least a partial map of the environment by accessing the memory.

10. A robotic cleaning device as claimed in claim 8, wherein the remote control comprises one of a smartphone and tablet, and an app.

11. A method of operating a robotic cleaning device to clean at least a portion of an environment to be cleaned, the method comprising:
vacuum cleaning a portion of the environment with a first pass;
detecting an amount of dirt in areas vacuum cleaned in the environment
creating a map of locations cleaned by the robotic cleaning device;
indicating on the map areas where more dirt is detected, and indicating those areas where more dirt is detected as intensive cleaning locations;
accessing the map of the environment to be cleaned;
identifying on the map first and second portions of the environment to be vacuum cleaned, the second portion being identified for vacuum cleaning more intensively than the first portion;
causing the robotic apparatus to traverse the first portion of the environment without cleaning to come back to the second portion;
in response to a recorded intensive cleaning location indicated on the map of intensive cleaning portions, causing the robotic apparatus to come back to the intensive cleaning portions and traverse the second portion of the environment while vacuum cleaning on a second pass in a second direction, such that the second portion is cleaned with multiple passes over at least part of the second portion, wherein the multiple passes are in different directions; and
powering the device with at least one battery, and checking the at least one battery's state of charge prior to vacuum cleaning the intensive cleaning portion on the second pass to insure there is sufficient battery charge for cleaning the intensive cleaning portion on the second pass.

12. A method of operating a robotic cleaning device as claimed in claim 11, wherein the multiple passes are in dominant and non-dominant directions that are perpendicular to each other.

13. A method of operating a robotic cleaning device as claimed in claim 11, further comprising, prior to the traversing recited in claim 11:
accessing a map of the environment to be cleaned; and
causing the robotic apparatus to traverse the environment to perform cleaning of the environment.

14. A method of operating a robotic cleaning device as claimed in claim 13, wherein the robotic apparatus traverses the environment in the dominant direction for the single pass over at least part of the first portion.

15. (canceled)

16. A method of operating a robotic cleaning device as claimed in claim 11, further comprising:
determining whether there is an additional portion of the environment which require further cleaning; and
if there is an additional portion of the environment which requires further cleaning, causing the robotic apparatus to travel to that additional portion of the environment to begin the traversing recited in claim 11 for that additional portion.

17. A method of operating a robotic cleaning device as claimed in claim 11, further comprising repeating the traversing in claim 11.

18. (canceled)

19. A method of operating a robotic cleaning device as claimed in claim 11, further comprising accessing the at least a partial map of the environment by accessing a memory.

20. A method of operating a robotic cleaning device as claimed in claim 11, further comprising remotely controlling operation of the device to identify the second, intensive cleaning portion.
